(19) United States
(12) Patent Application Publication
(10) Pub. No.: US 2019/0000042 A1
(43) Pub. Date: Jan. 3, 2019

(54) PET SUPPORT SYSTEM

(71) Applicant: Carol Millar-Harding, Brooklyn, NY (US)

(72) Inventor: Carol Millar-Harding, Brooklyn, NY (US)

(21) Appl. No.: 15/640,637

(22) Filed: Jul. 3, 2017

(51) Int. Cl. A01K 23/00; A41D 19/00

(52) U.S. Cl. CPC A01K 23/00; A41D 19/0082

(57) ABSTRACT

An animal diaper garment kit that includes a pair of gloves and an animal diaper garment assembly including an hour-glass sheet having an upper panel having at least one first fastener, a central panel having a first aperture and second aperture, a lower panel having at least one second fastener, and an outside liner covering the hour-glass sheet and captures any animal urine or feces seeping through the hour-glass sheet. The animal diaper garment kit acts as an animal waste collection system to provide an owner of the animal an efficient and sanitary way of collecting and discarding animal waste without coming into contact with the excrements.

### CROSS-REFERENCE TO RELATED APPLICATION

The present application is related to and claims priority from prior provisional application Ser. No. 61/924,335, filed Jan. 7, 2014, and non-provisional application Ser. No. 14/588,954, filed Apr. 1, 2015, which applications are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of diapers for animals and more specifically relates to an animal diaper garment system.

### 2. DESCRIPTION OF THE RELATED ART

America is a country of dog lovers. In fact, according to the American Pet Products Manufacturers Association, (APPMA) there are approximately 60 million owned dogs in the United States. A simpler means of understanding these figures is to say that four in ten households include a family dog. Why do so many people own dogs? The answer to that question is simple; dogs provide unconditional love, companionship and unmatched loyalty to their owners. Known as “man's best friend”, dogs offer protection and are faithful and constant friends. For many owners, a favorite end to a hectic day is spent curled up on a sofa or chair, with a beloved dog nestled nearby. Because dogs are more often considered a member of the family, as opposed to merely a pet, most owners provide adequate shelter, as well as a healthy diet for their animals.

Although a dog is a delightful addition to any family, cleaning up after them can be unpleasant at best. Specifically, collecting and disposing of waste matter is an unsettling task, however, most conscientious dog owners realize that it is one which must be done. In particular, those who live in cities and suburban areas are required by laws and local ordinances to remove dog waste from sidewalks and lawns immediately after the animal has answered the call of nature. For those who live in less populated areas, removing pet waste is a key factor in maintaining an attractive and well-kept yard. Most people collect their dog's waste in either a plastic bag or tissue. Unsanitary and disagreeable, picking up waste matter by hand can be a daunting job. Others collect the waste through use of a pet scooper.

Although scoopers offer a hands-free means of picking up after one's pet, their handles are short and their use requires a person to stoop to the ground in order to retrieve the waste. For those with physical limitations such as arthritis, back or knee problems, bending or stooping over in order to clean up after an animal can cause pain and discomfort. This is especially true for senior citizens and those who suffer varying degrees of limited mobility. Should the user fail to properly clean up after their pet, the result can be that someone steps into the fecal matter, rendering them exposed to the harmful germs and bacteria associated with this matter. This is not desirable.

Various attempts have been made to solve problems found in diapers for animals art. Among these are found in: U.S. Pub. No. 2006/0149203 to Roland James Draper et al; U.S. Pat. No. 6,142,105 to William R. McKnight; and U.S. Pub. No. 2003/0066495 to Daryl Soares et al. This prior art is representative of diapers for animals. None of the above inventions and patents, taken either singly or in combination, is seen to describe the invention as claimed.

Ideally, an animal diaper garment system would be user-friendly and safe in-use and, yet may operate reliably and be manufactured at a modest expense. Thus, a need exists for an animal diaper garment kit and system that acts as an animal waste collection system and device to provide an owner of the animal an efficient and sanitary way of collecting and discarding animal waste without coming into contact with the excrements and to avoid the above-mentioned problems.

### BRIEF SUMMARY OF THE INVENTION

In view of the foregoing disadvantages inherent in the known diapers for animals art, the present invention provides a novel animal diaper garment system (also referred to herein as ‘Pet Support System’). The general purpose of the present invention, which will be described subsequently in greater detail is to provide an animal diaper garment system that acts as an animal waste collection device to provide an owner of the animal an efficient and sanitary way of collecting and discarding animal waste.

An animal diaper garment kit and system is disclosed herein in a preferred embodiment comprising: an animal diaper garment assembly including an hour-glass sheet cut to a pre-selected size to form an animal diaper having an upper panel having at least one first fastener; a central panel having a first aperture, and a second aperture; and a lower panel having at least one second fastener, and an outside liner covering the hour-glass sheet and captures any animal urine or feces seeping through the hour-glass sheet. The animal diaper garment kit and system comprises the animal diaper garment assembly. The upper panel, the central panel, and the lower panel comprise the animal diaper. The animal diaper garment assembly kit acts as an animal waste collection device to provide an owner of the animal an efficient and sanitary way of collecting and discarding animal waste without coming into contact with the excrements.

The animal diaper garment assembly further comprises at least one scent to mask odors when the animal diaper garment assembly becomes soiled by the animal excrements. The animal diaper garment assembly further comprises at least one odor neutralizer to neutralize odors when the animal diaper garment assembly becomes soiled by the animal excrements. The animal diaper garment assembly is disposable. The animal diaper garment assembly preferably comprises thermo-mechanically expanded polytetrafluoroethylene material, the thermo-mechanically expanded polytetrafluoroethylene material is breathable and leak-proof thereby preventing the animal excrements from exiting out of the diaper garment assembly prior to disposal.

The upper panel comprises a first rectangular profile for functional use. The upper panel is wrappable around said user-animal for an in-use condition, the upper panel structured and arranged to cover a first lower back and a first hip region.

The central panel comprises a convex profile. The first aperture accommodates a first leg of the user-animal when in the in-use condition. The second aperture accommodates a second leg of the user-animal when in the in-use condition. The central panel when forming the animal diaper wraps around the user-animal is in the in-use condition, the central panel covers a torso region including a genital region of the user-animal and acts in a capacity of a diaper for collecting bodily fluids passed as excrement. The central panel when forming the animal diaper further comprises a first partition for use by a neutered and non-neutered male animal designed to collect solid animal excrements including fecal matter and prevent unwanted contact of the fecal matter with testicles of the male animal. The central panel when forming the animal diaper further comprises a second partition for use by the neutered and non-neutered male animal designed to collect liquid said animal excrements including urine and blood.

The lower panel comprises a second rectangular profile for functional use. The lower panel is wrappable around the user-animal for an in-use condition; the lower panel structured and arranged to cover a second lower back region and a second hip region. When the animal diaper is wrappable around the user-animal, the upper panel and lower panel meet to form the animal diaper. The at least one first fastener located on the upper panel and the at least one second fastener located on the lower panel are removably-coupled to one another thereby securing the animal diaper in place and preventing unwanted displacement around the genital region. The at least one first fastener located on the upper panel comprises a hook and loop system. The at least one second fastener located on the lower portion preferably comprises a hook and loop system.

Furthermore, an outside liner covering the hour-glass sheet and captures any animal urine or feces seeping through the hour-glass sheet.

A kit is also embodied herein for the animal diaper garment system comprising a pair of gloves, and a plurality of animal diaper garment assemblies in a user-preferred size ranging from small to extra-large to accommodate small said animals to large said animals in both male and female versions in a variety of colors and designs, and a set of user-instructions.

A method of using an animal diaper garment system is disclosed herein comprising the steps of: choosing an animal diaper garment assembly in a user-preferred size to fit a user-animal; inserting a first leg of the animal through a first aperture located on a central panel; inserting a second leg of the animal through a second aperture; wrapping the central panel having the diaper around a genital region of the user-animal; wrapping an upper panel having at least one first fastener around a first lower back and a first hip region of the user-animal; wrapping a lower panel having at least one second fastener around a second lower back region and a second hip region of the user-animal; mating the at least one first fastener located on the upper panel and the at least one second fastener located on the lower panel to one another thereby securing the animal diaper in place and preventing unwanted displacement around the genital region of the user-animal; the animal removing bodily fluids in a form of animal excrements into the animal diaper garment assembly; unfastening the at least one first fastener from the at least one second fastener; removing the animal diaper garment assembly from the user-animal once soiled; and discarding the animal diaper garment assembly into a trash receptacle.

The present invention holds significant improvements and serves as an animal diaper garment system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, animal diaper garment system (also referred to herein as ‘Pet Support System’) constructed and operative according to the teachings of the present invention.

FIG. 1 shows a perspective view illustrating an animal diaper garment system in an in-use condition according to an embodiment of the present invention.

FIG. 2 is a front perspective view illustrating an animal diaper garment assembly in a disposable form for use by a male animal of the animal diaper garment system according to an embodiment of the present invention of FIG. 1.

FIG. 3 is a front perspective view illustrating an animal diaper garment assembly in a re-useable for use by a female animal of the animal diaper garment system according to an embodiment of the present invention of FIG. 1.

FIG. 4 is a perspective view illustrating a kit of the animal diaper garment system according to an embodiment of the present invention.

FIG. 5 is a flowchart illustrating a method of use for the animal diaper garment system according to an embodiment of the present invention of FIGS. 1-4.

FIG. 6 is a perspective view illustrating a pair of gloves that can be used and sold with the animal diaper garment system as a kit.

FIG. 7 is a perspective view illustrating an outside liner attached to and covering the animal diaper.

The various embodiments of the present invention will hereinafter be described in conjunction with the appended drawings, wherein like designations denote like elements.

### DETAILED DESCRIPTION

As discussed above, embodiments of the present invention relate to a diapers for animals apparatus and more particularly to an animal diaper garment system (entitled ‘Pet Support System’) that acts as an animal waste collection device to provide an owner of the animal an efficient and sanitary way of collecting and discarding animal waste without coming into contact with the excrements.

Generally speaking, the Pet Support System comprises a specially designed pet waste collection device, configured in the form of a wearable, diaper-like brace that is applied to the animal's lower extremities and inside of which the animal may directly eliminate waste matter. The disposable Pet Support System is preferably comprised of a breathable, yet leak-proof Gore-Tex or comparable material. As this device is disposable, a consideration may be to include liners manufactured of plastic-backed sanitary paper or comparable absorbent material that may be discarded following use. Fabric coverings for the Pet Support may also be offered in the line and may be manufactured of cotton or suede.

The Pet Support System may be designed to encompass the animal's lower trunk and thus may wrap about the dog's hind legs and midway up the abdomen and lower back. A series of simple VELCRO® fasteners may be included that may enable the user to comfortably secure the garment about the animal's body, as well as make any necessary adjustments for a secure and comfortable fit. The Pet Support System designed for wear by non-neutered male dogs may feature an integrated partition designed to collect solid waste residue and prevent it from collecting behind the animal's testicles, while a second, reinforced partition may be included to collect liquid waste matter.

Versions of the Pet Support System for wear by female canines may be designed without the partition enhancement. Each Pet Support System may be lightly imbued with an odor neutralizer or other fresh scented formula that serves to bate owners after the animal has eliminated waste. Offered in a wide range of sizes to accommodate toy, small, medium and large dog breeds, the Pet Support System may be offered for sale in multi-count packages facilitating convenient use in the home or on the go. Use of the Pet Support System may facilitate the sanitary collection and disposal of dog waste.

A uniquely designed wearable garment that collects all liquid and solid waste matter, the Pet Support System may provide a practical alternative to allowing the animal to urinate or defecate directly on the ground, just to have to follow behind the animal, collecting its waste. Sparing the caring pet owner the hassle of bending over to scoop up pet waste, the Pet Support System may also prove useful for seniors, as well as dog lovers who suffer limited mobility, arthritis, knee problems or back pain.

Further, as this device may encompass the animal's genitalia, the Pet Support System may effectively prevent dogs from copulating in the event a female dog is in heat. The Pet Support System may also prove invaluable for use when a female dog is menstruating, protecting furnishings and flooring from associated stains. An environmentally friendly invention, use of the Pet Support System may help to keep neighborhood sidewalks, parks and the home landscape clean and free of unwanted and germ-filled debris that may spread illness and disease. As such, the Pet Support System protect the health and well-being of consumers, sparing them direct exposure to noxious dog waste.

An aesthetically attractive garment, the Pet Support System may come in various colors. Further, as this device may be lightly scented, lingering odors associated with animal waste may effectively be eliminated. Leak-proof and weather resistant, the Pet Support System may easily withstand the movements of an active canine, as well as exposure to the rain and snow. Easily removed following use, the Pet Support System may provide a sealable receptacle inside of which the collected waste may be easily contained and disposed.

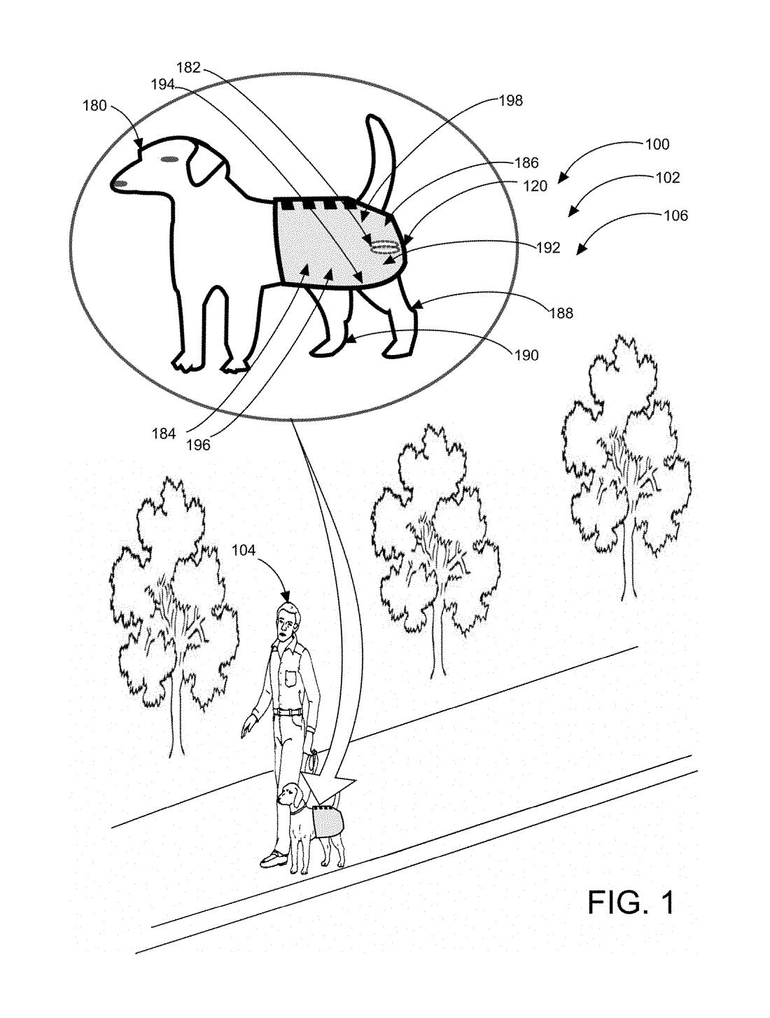

Referring now to the drawings by numerals of reference there is shown in FIGS. 1-3, 6, and 7 perspective views illustrating animal diaper garment system assembly 102 of animal diaper garment system 100 according to an embodiment of the present invention.

Animal diaper garment system 100 comprises: animal diaper garment assembly 102 including hour-glass sheet 110 cut to a pre-selected size to form animal diaper 120 having upper panel 130 having at least one first fastener 140; central panel 150 having first aperture 156, and second aperture 158; and lower panel 170 having at least one second fastener 174. Animal diaper garment system 100 comprises animal diaper garment assembly 102. Upper panel 130, central panel 150, and lower panel 170 comprise animal diaper 120.

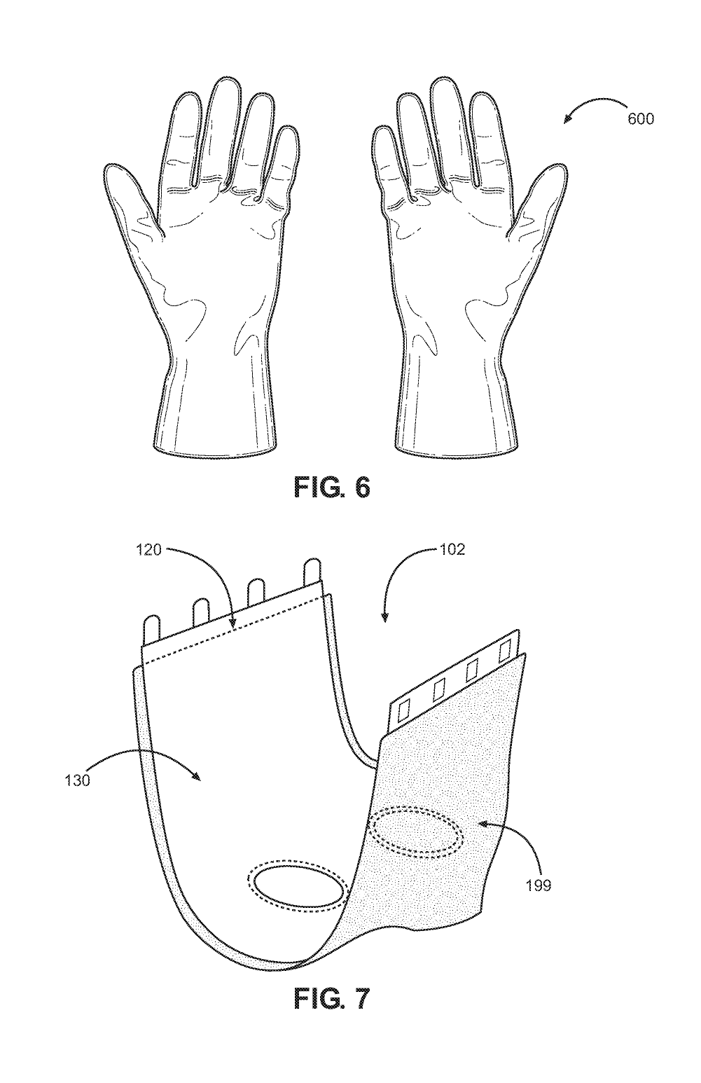

As illustrated in FIG. 6, a pair of gloves 600 can be used and sold with the animal diaper 120 as a “kit” and are adapted to protect a user's hands from a animal's urine or feces and any such excrement thereon, and are adapted to be used to handle and manipulate the animal diaper garment assembly after use. The pair of gloves 600 are formed from a waterproof material, such as plastic or rubber.

As illustrated in FIG. 7, an outside liner 199 is attached to and substantially covers the animal diaper 120 and is adapted to capture any animal urine or feces seeping therethrough. Outside liner 199 can be formed from cotton or plastic. The outside liner 199 can attached to the animal diaper 120 via methods such as adhesives, heating, stitching, and like methods.

Animal diaper garment assembly 102 acts as an animal waste collection device to provide owner 104 of animal 180 an efficient and sanitary way of collecting and discarding animal waste without coming into contact with excrements 182.

Animal diaper garment assembly 102 may further comprise at least one scent to mask odors when animal diaper garment assembly 102 becomes soiled by animal excrements 192. Animal diaper garment assembly 102 further comprises at least one odor neutralizer to neutralize odors when animal diaper garment assembly 102 becomes soiled by animal excrements 182.

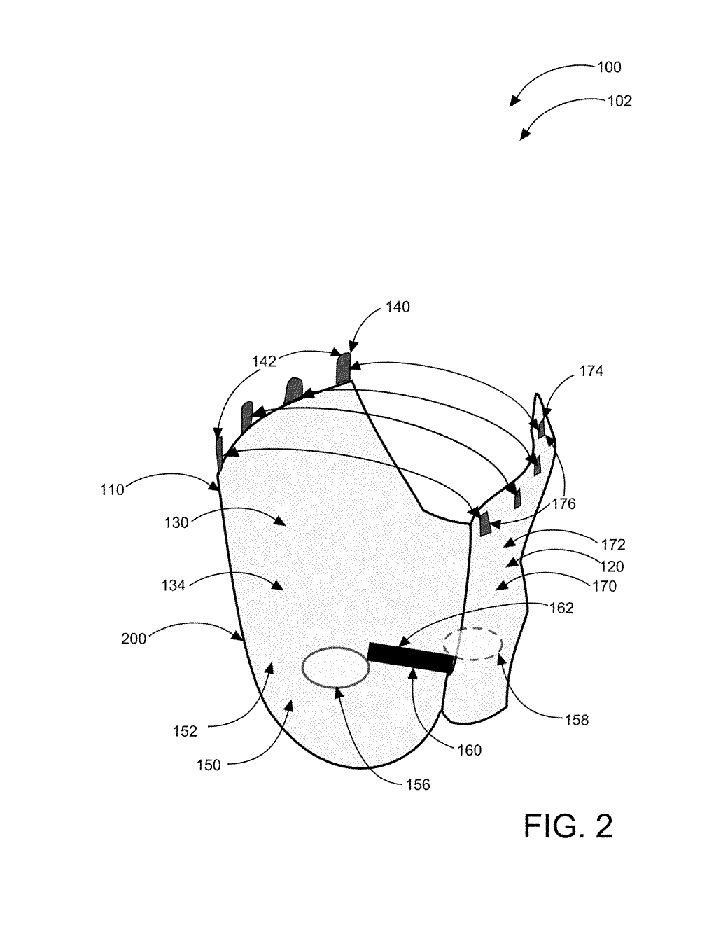

Animal diaper garment assembly 102 may be disposable in a preferred embodiment as shown in FIG. 2. Animal diaper garment assembly 102 may comprise thermo-mechanically expanded polytetrafluoroethylene material, the thermo-mechanically expanded polytetrafluoroethylene material is breathable and leak-proof thereby preventing animal excrements from exiting out of diaper garment assembly 102 prior to disposal when in the disposable form. Other suitable materials may be used.

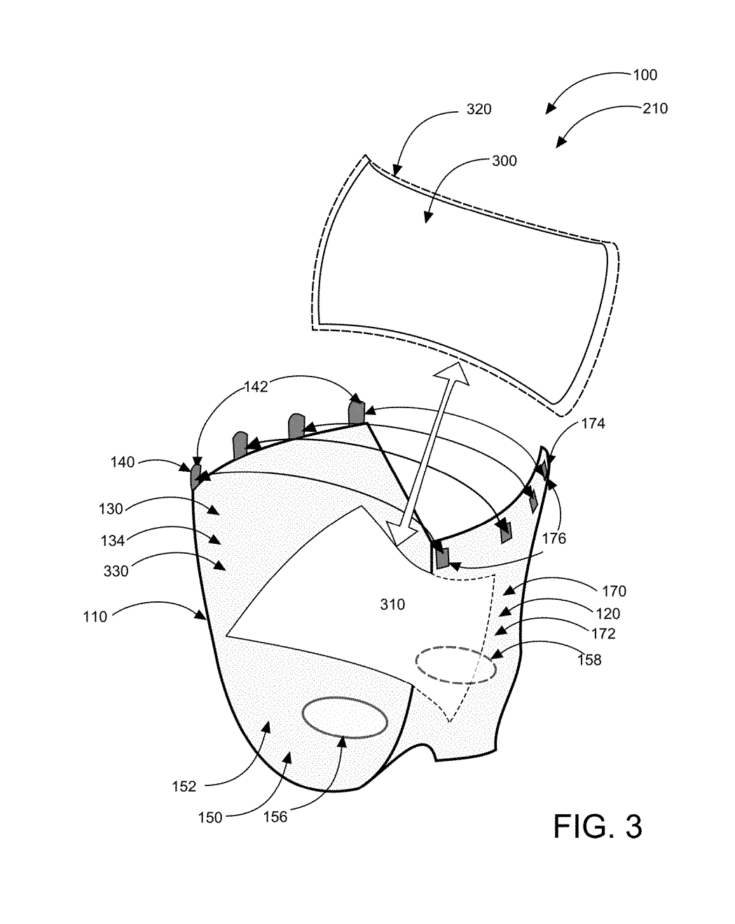

Animal diaper garment assembly 102 may be re-useable in an alternate embodiment as shown in FIG. 3. Animal diaper garment assembly 102 further comprises removable liner 300 of absorbent material having at least one adhesive 310 that is removed after becoming soiled with animal excrements 182. Removable liner 300 further comprises a protective peel-away sheet 320 to protect at least one adhesive 310. Animal diaper garment assembly 102 may comprise cotton due to its inherent stretchability and durability properties. Upon reading this specification, it should be appreciated that, under appropriate circumstances, considering such issues as user preferences, design preference, structural requirements, marketing preferences, cost, available materials, technological advances, etc., other re-useable material arrangements such as, for example, suede, leather, vinyl, cloth, etc., may be sufficient.

Upper panel 130 comprises first rectangular profile 134 for functional use. Upper panel 130 is wrappable around user-animal 180 for in-use condition 106 as shown in FIG. 1, upper panel 130 structured and arranged to cover first lower back 184 and first hip region 186.

Central panel 150 comprises convex profile 152. First aperture 156 accommodates first leg 188 of user-animal 180 when in in-use condition 106. Second aperture 162 accommodates second leg 190 of user-animal 180 when in in-use condition 106 also shown in FIG. 1. Central panel 150 when forming animal diaper 120 wraps around user-animal 180 is in in-use condition 106, central panel covers torso region 192 including genital region 194 of user-animal 190 and acts in a capacity of diaper 120 for collecting bodily fluids passed as excrement 182.

Central panel 150 when forming animal diaper 120 further comprises first partition 160 for use by a neutered and non-neutered male animal 180 designed to collect solid animal excrements 182 including fecal matter and prevent unwanted contact of the fecal matter with testicles of male animal 190 as shown in male version 200 of animal diaper 120 FIG. 2. Central panel when forming animal diaper 120 further comprises second partition 162 for use by the neutered non-neutered male animal 180 designed to collect liquid animal excrements 182 including urine and blood. In an alternate embodiment, central panel 150 when forming animal diaper 120 does not include first partition 160 and second partition 162 for wear by a female animal 190 for collecting animal excrements 182 and during menstruation as shown in female version 330 of FIG. 3.

Lower panel 170 comprises second rectangular profile 172 for functional use. Lower panel 170 is wrappable around user-animal 180 for in-use condition 106, lower panel 170 structured and arranged to cover second lower back region 196 and second hip region 198. When animal diaper 120 is wrappable around user-animal 180, upper panel 130 and lower panel 170 meet to form animal diaper 120. At least one first fastener 140 located on upper panel 130 and the at least one second fastener 174 located on lower panel 170 are removably-coupled to one another thereby securing animal diaper 120 in place and preventing unwanted displacement around genital region 194. At least one first fastener 140 located on upper panel 130 comprises hook and loop system 142. At least one second fastener 174 located on lower portion 170 also comprises hook and loop system 176. Upon reading this specification, it should be appreciated that, under appropriate circumstances, considering such issues as user preferences, design preference, structural requirements, marketing preferences, cost, available materials, technological advances, etc., other first fastener and second fastener arrangements such as, for example, buttons, snaps, adhesives, etc., may be sufficient.

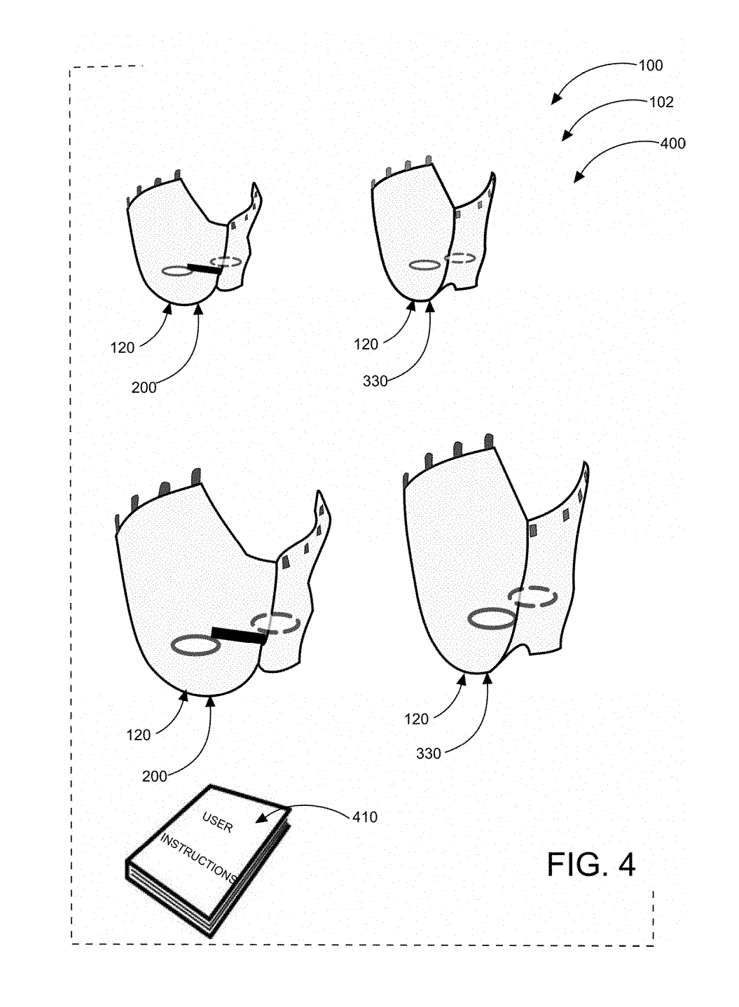

Referring now to FIG. 4 showing a perspective view illustrating kit of animal diaper garment system 100 according to an embodiment of the present invention of FIG. 1

Kit 400 is embodied herein for animal diaper garment system 100 comprising plurality of animal diaper garment assemblies 102 in a user-preferred size ranging from small to extra-large to accommodate animals 180 from small in size to larger in size in both male and female versions in a variety of colors and designs, and set of user-instructions 410. Animal diaper garment system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, parts may be sold separately, etc., may be sufficient.

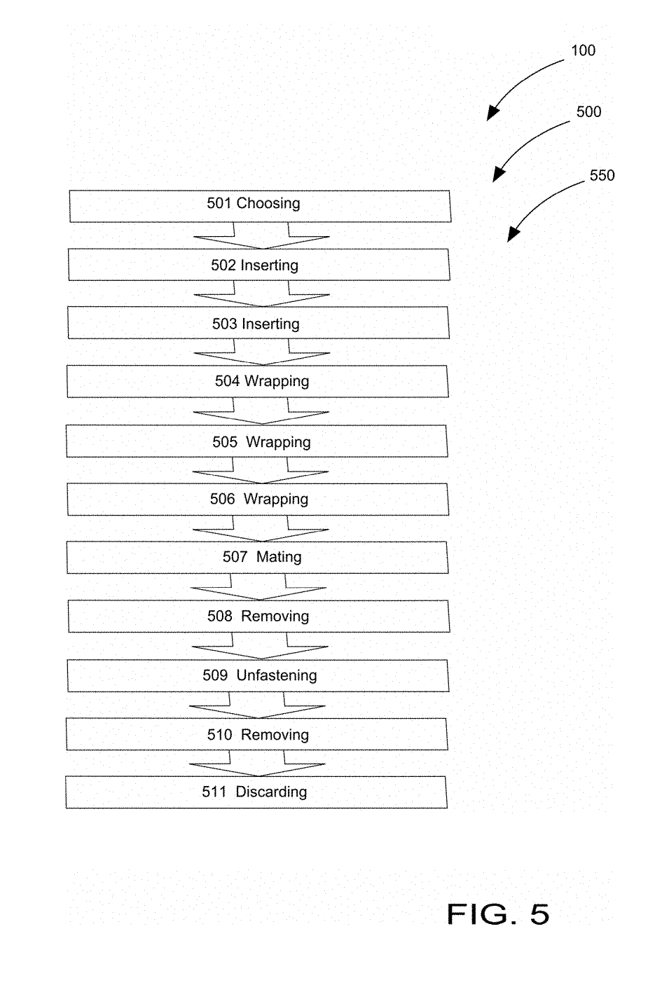

Referring now to FIG. 5, flowchart 550 illustrating method of use 500 for animal diaper garment system is 100 according to an embodiment of the present invention of FIGS. 1-4.

Method of using (method of use 500) animal diaper garment system 100 comprises the steps of: step one 501 choosing animal diaper garment assembly 102 in a user-preferred size to fit user-animal 180; step two 502 inserting first leg 188 of animal 180 through first aperture 156 located on central panel 150; step three 503 inserting second leg 190 of animal 180 through second aperture 158; step four 504 wrapping central panel 150 having diaper 120 around genital region 194 of user-animal 180; step five 505 wrapping upper panel 130 having at least one first fastener 140 around first lower back 184 and first hip region 186 of user-animal 180; step six 506 wrapping lower panel 170 having at least one second fastener 174 around second lower back region 196 and second hip region 198 of user-animal 180; step seven 507 mating at least one first fastener 140 located on upper panel 130 and at least one second fastener 174 located on lower panel 170 to one another thereby securing animal diaper 120 in place and preventing unwanted displacement around genital region 194 of user-animal 180; step eight 508 animal 180 removing bodily fluids in a form of animal excrements 182 into animal diaper garment assembly 102; step nine 509 unfastening at least one first fastener 140 from at least one second fastener 174; step ten 510 removing animal diaper garment assembly 102 from user-animal 180 once soiled; and step eleven 511 discarding animal diaper garment assembly 102 into a trash receptacle.

As illustrated in FIG. 6, a pair of gloves 600 can be used and sold with the animal diaper 120 as a “kit” and are adapted to protect a user's hands from a animal's urine or feces and any such excrement thereon, and are adapted to be used to handle and manipulate the animal diaper garment assembly after use. The pair of gloves 600 are formed from a waterproof material, such as plastic or rubber.

As illustrated in FIG. 7, an outside liner 199 is attached to and substantially covers the animal diaper 120 and is adapted to capture any animal urine or feces seeping therethrough. Outside liner 199 can be formed from cotton or plastic. The outside liner 199 can attached to the animal diaper 120 via methods such as adhesives, heating, stitching, and like methods.

It should be noted that the steps described in the method of use can be carried out in many different orders according to user preference. The use of “step of” should not be interpreted as “step for”, in the claims herein and is not intended to invoke the provisions of 35 U.S.C. § 112, 16. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An animal diaper garment kit comprising:
a pair of gloves:
wherein said pair of gloves are adapted to protect a user's hands from animal's urine a feces, and are adapted to be used to handle and manipulate an animal diaper garment assembly; and
an animal diaper garment assembly having:
an hour-glass sheet cut to a pre-selected size to form an animal diaper having:
an upper panel having at least one first fastener;
a central panel having:
a first aperture, and
a second aperture; and
a lower panel having at least one second fastener; and
an outside liner;
wherein said outside liner is adapted to be attached to and substantially covers said hour-glass sheet and is adapted to capture any animal urine or feces seeping through said hour-glass sheet;
wherein said upper panel is wrappable around a user-animal for an in-use condition, said upper panel structured and arranged to cover a first lower back and a first hip region;
wherein said central panel comprises a convex profile;
wherein said first aperture accommodates a first leg of said user-animal when in said in-use condition;
wherein said second aperture accommodates a second leg of said user-animal when in said in-use condition;
wherein said central panel when forming said animal diaper wraps around said user-animal in said in-use condition, said central panel covers a torso region including a genital region of said user-animal and acts in a capacity of a diaper for collecting bodily fluids passed as excrement;
wherein said lower panel comprises a second rectangular profile for functional use;
wherein said lower panel is wrappable around said user-animal for said in-use condition, said lower panel structured and arranged to cover a second lower back region and a second hip region;
wherein when said animal diaper is wrappable around said user-animal, said upper panel and lower panel meet to form said animal diaper;
wherein said at least one first fastener located on said upper panel and said at least one second fastener located on said lower panel are removably-coupled to one another thereby securing said animal diaper in place and preventing unwanted displacement around said genital region; and
wherein said animal diaper garment assembly acts as an animal waste collection device to provide an owner of said animal an efficient and sanitary way of collecting and discarding animal waste without coming into contact with said excrements.

2. The animal diaper garment kit of claim 1 wherein said animal diaper garment assembly further comprises at least one scent to mask odors when said animal diaper garment assembly becomes soiled by said animal excrements.

3. The animal diaper garment kit of claim 1 wherein said animal diaper garment assembly further comprises at least one odor neutralizer to neutralize odors when said animal diaper garment assembly becomes soiled by said animal excrements.

4. (canceled)

5. (canceled)

6. The animal diaper garment kit of claim 1 wherein said animal diaper garment assembly is re-useable.

7. The animal diaper garment kit of claim 6 wherein said animal diaper garment assembly comprises cotton due to its inherent stretchability and durability properties.

8. The animal diaper garment kit of claim 6 wherein said animal diaper garment assembly comprises suede to provide durability and body-contouring.

9. The animal diaper garment kit of claim 6 wherein said animal diaper garment assembly further comprises a removable liner of absorbent material having at least one adhesive that is removed after becoming soiled with said animal excrements.

10. The animal diaper garment kit of claim 9 wherein said removable liner further comprises a protective peel-away sheet to protect said at least one adhesive.

11. The animal diaper garment kit of claim 1 wherein said at least one first fastener comprises a hook and loop system.

12. The animal diaper garment kit of claim 1 wherein said at least one first fastener comprises adhesive.

13. The animal diaper garment kit of claim 1 wherein said at least one second fastener comprises a hook and loop system.

14. The animal diaper garment kit of claim 1 wherein said at least one second fastener comprises adhesive.

15. (canceled)

16. (canceled)

17. (canceled)

18. (canceled)

19. (canceled)

20. (canceled)
